(19) United States
(12) Patent Application Publication
(10) Pub. No.: US 2025/0176694 A1
(43) Pub. Date: Jun. 5, 2025

(54) SMART HAIR DRYER

(71) Applicant: Spur Concepts Inc, San Diego, CA (US)

(72) Inventors: Ryan Goldman, San Diego, CA (US); Jonathan Friedman, San Diego, CA (US); Zachary Rattner, San Diego, CA (US)

(73) Assignee: Spur Concepts Inc., San Diego, CA (US)

(21) Appl. No.: 19/050,113

(22) Filed: Feb. 10, 2025

Related U.S. Application Data
(63) Continuation-in-part of application No. 18/957,628, filed on Nov. 22, 2024.
Application No. 18/957,628 is a continuation of application No. 18/367,153, filed on Sep. 12, 2023, now Pat. No. 12,178,303.
Application No. 18/367,153 is a continuation of application No. 16/910,026, filed on Jun. 23, 2020, now Pat. No. 11,751,657.
(63) Continuation-in-part of application No. 18/975,974, filed on Dec. 10, 2024.
Application No. 18/975,974 is a continuation of application No. 17/317,160, filed on May 11, 2021, now Pat. No. 12,161,209.
Application No. 17/317,160 is a continuation of application No. 16/565,449, filed on Sep. 9, 2019, now Pat. No. 11,000,104.
(63) Continuation-in-part of application No. 18/622,911, filed on Mar. 30, 2024.
Application No. 18/622,911 is a continuation of application No. 17/083,219, filed on Oct. 28, 2020, now Pat. No. 11,944,176.

(51) Int. Cl. A45D 20/12; A45D 20/10; F26B 21/00; F26B 21/10; F26B 23/04; F26B 23/06; H01M 10/613; H01M 10/623; H01M 10/6235; H01M 10/643; H01M 10/6563; H01M 50/213

(52) U.S. Cl. CPC A45D 20/12; A45D 20/10; F26B 21/001; F26B 21/10; F26B 23/04; F26B 23/06; H01M 10/613; H01M 10/623; H01M 10/643; H01M 10/6563; H01M 50/213; A45D 2200/00; H01M 10/6235; H01M 2200/10; H01M 2220/30

(57) ABSTRACT

A system and method for an intelligent hair dryer with capabilities to transmit information to/from an external device. The hair dryer houses control circuitry, such as a processor and control circuit board to control the hair dryer. The hair dryer may include one or more sensors configured to provide information to the control circuitry to perform various functions. The control circuitry may communicate the information to the external device.

### CROSS-REFERENCE TO RELATED APPLICATIONS

This application is a continuation-in-part of U.S. patent application Ser. No. 18/957,628, filed Nov. 22, 2024, which is a continuation of U.S. patent application Ser. No. 18/367,153, filed on Sep. 12, 2023, which is a continuation of U.S. patent application Ser. No. 16/910,026, filed on Jun. 23, 2020, which is a continuation of U.S. patent application Ser. No. 16/038,020, filed on Jul. 17, 2018, which is a continuation of U.S. patent application Ser. No. 15/663,735, filed on Jul. 29, 2017, which claims priority from U.S. Provisional Patent Application No. 62/368,962, filed on Jul. 29, 2016, all of which are incorporated herein by reference.

This application is a continuation-in-part of U.S. patent application Ser. No. 18/975,974, filed on Dec. 10, 2024, which is a continuation of U.S. patent application Ser. No. 17/317,160, filed on May 11, 2021, which is a continuation of U.S. patent application Ser. No. 16/565,449, filed on Sep. 9, 2019, which is a continuation of U.S. patent application Ser. No. 15/660,601, filed on Jul. 26, 2017, which claims priority from U.S. Provisional Patent Application No. 62/368,962, filed on Jul. 29, 2016, all of which are incorporated herein by reference.

This application is a continuation-in-part of U.S. patent application Ser. No. 18/622,911, filed Mar. 30, 2024, which is a continuation of U.S. patent application Ser. No. 17/083,219, filed Oct. 28, 2020, which is a continuation-in-part of U.S. patent application Ser. No. 15/663,735, filed Jul. 29, 2017, which is a continuation-in-part of U.S. patent application Ser. No. 15/660,601, filed Jul. 26, 2017, both of which claim the benefit of U.S. Provisional Application No. 62/368,962, filed on Jul. 29, 2016, all of which are incorporated herein by reference.

This application is related to Ser. No. 17/348,674 filed Mar. 30, 2020, which is a continuation of Ser. No. 16/833,966 filed Mar. 30, 2020, which was a continuation of U.S. patent application Ser. No. 15/937,757, filed Mar. 27, 2018, which was a continuation-in-part of U.S. patent application Ser. No. 15/663,735, filed Jul. 29, 2017, and a continuation-in-part of U.S. patent application Ser. No. 15/660,601, filed Jul. 26, 2017, both of which claim the benefit of U.S. Provisional Application No. 62/368,962, filed on Jul. 29, 2016, which are incorporated herein by reference

### FIELD

This invention relates to the general field of hair dryers, and specifically toward a hair dryer having smart features.

### BACKGROUND

Although humans have a large range of different hair types: density, length, coarseness, sheen, moisture content, follicle thickness, curliness, and others, hair dryers are traditionally “one-size fits all” and treat all hair the same. The primary aspects involved in the majority of hair drying/styling devices involve a simple resistive wire (usually nichrome) for the heating element. When power is supplied to the hair dryer, the heating coil responds by quickly heating the air within the apparatus. The heated air is then forcefully expelled out of the device by means of a rotating fan. This results in accelerating the process of removing moisture absorbed within the hair follicle by rapidly heating the temperature of the hair. Hair can be damaged from overheating created by these powerful dryers.

The majority of hair drying devices involve a heating coil and a rotating fan housed within a protective outer shell. The heating coil is a resistive wire that dissipates heat when electric current is passed through it. When power is supplied, the heating coil responds by heating the air within the apparatus and the heated air is forcefully expelled out of the device by the rotating fan. Such heating coils are relatively inexpensive and heat up quickly. Use of the hair drying device results in accelerating the process of removing moisture absorbed within the hair follicle by rapidly heating the temperature of the hair.

Due to a multitude of variabilities, the structure of hair follicles varies per person, with each individual requiring a customized setting for the level of heat generated by the heating coil and the speed of which the hot air is expelled from the hair drying/styling device. Offering a standard amount of different control settings for heat and speed allows for greater device control but fails to address the complexity of variables of an individual's hair follicle structure.

While many companies already produce hundreds of different types of hair dryers, none provide a comprehensive and intelligent feedback mechanism and interactive experience to optimize the drying and styling of hair.

It would be desirable to provide a hair dryer having smart features. It would further be desirable if the hair dryer included wireless communication features to update or adjust the hair dryer to improve the hair drying/styling experiences.

### SUMMARY

Then present invention is directed to a smart hair dryer have advanced features including:
WIRELESS COMMUNICATION—the hair dryer is capable of wireless communication with external devices;
DIRECT COMMUNICATION—the hair dryer is capable of direct communication with external devices;
PROGRAMMABLE—the hair dryer is programmable;
HAIR DRYER MODES—hair dryer includes different modes of operation;
AUTOMATIC REGISTRATION—the hair dryer automatically registers when activated;
POWER RECOGNITION—the hair dryer recognizes presence of power when plugged in;
SENSORS—a variety for detecting various properties during hair drying, such as:
   a thermometer to measure hair temperature;
   a distance sensor to measure distance to the hair;
   an inertial sensor to measure the hair dryer's orientation and motion;
   a sensor that determines when the hair dryer is pointed at the hair
   a camera coupled with computer vision technologies to determine a user's hair type and style;
   diagnostic mechanisms configured to insure proper operation;
   a force sensor to determine how the user is holding the handle and provide feedback;
   an EMF sensor determines the presence of magnetic fields to protect the user from damaged cells;
   a vibration sensor to determine shock if the hair dryer unit has been dropped or damaged;
   a light sensor to determine how effective a camera sensor will be in analyzing the hair wetness.
PROFILE—information from the hair dryer is used to build a profile of the user's hair
FEEDBACK MECHANISM—configured to communicate hair dryer information with the user in real-time
STERILIZER—the hair dryer includes ultraviolet light source inside of the hair dryer configured to sterilize the inside of the hair dryer and/or sterilize the air flowing through the hair dryer.

In order to communicate with external sources (cloud server, phone, etc.) the hair dryer may contain communications capability using a wired or direct connection or a wireless connection having cellular, Wi-Fi and/or Bluetooth capabilities. When connected to the internet, the hair dryer can send and retrieve information from a remote device or server.

Once the dryer is connected to the internet, the hair dryer functionality can be further advanced. The sensors in the hair dryer could communicate information to adapt performance and optimize drying hair without damage. In addition, external information could be communicated to the hair dryer. For example, a thermostat could share ambient room temperature and humidity information to the device. Furthermore, the user's personal profile could be shared with the external device or server. This would enable the user's personal profile to be shared across multiple devices, as well as enabling the user to view and update the profile information. For example, when the user is traveling, a hotel dryer could adopt the parameters that were configured by the unit at home. Furthermore, parameters learned by a dryer could be shared where relevant to other styling products such as a flat iron, hot brush, etc.

The hair dryer usage information could also be shared with the external device or server for the purposes of comparing the user's usage patterns against other individuals, industry best practices, or aggregate metrics. Such a system would enable the hair dryer to coach the user in improving their styling habits as they are used.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present embodiments may be understood from the following detailed description when read in conjunction with the accompanying FIGs. It is emphasized that the various features of the figures are not necessarily to scale. On the contrary, the dimensions of the various features may be arbitrarily expanded or reduced for clarity.

FIGS. 1A, 1B shows one embodiment of a hair dryer.

FIG. 2 shows an exploded view of the components of the hair dryer.

FIG. 3 shows one embodiment of a heating element system.

FIG. 4 shows an exploded view of another embodiment of a heating element system.

FIG. 5 shows a directional infrared bulb.

FIG. 6 shows the initial temperature warmup ramp for two heat sources: 1) resistive wire component; 2) infrared bulb.

FIG. 7 shows one embodiment of hybrid heating element system that combines an infrared bulb with a resistive wire component.

FIG. 8 shows a schematic of a hybrid heating element system coupled to the electronics or control circuitry.

FIG. 9 is a block diagram overview showing one embodiment of functionality components of the control circuitry of the hair dryer.

FIG. 10 shows various features of the invention.

### DETAILED DESCRIPTION

Embodiments of the invention will now be described with reference to the FIGs, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The present invention is directed to a smart hair dryer have advanced features including:
WIRELESS COMMUNICATION
   The hair dryer is capable of wireless communication with external devices, such as a smartphone, computer, tablet, etc. The wireless communication may use one or more wireless types, such as cellular, Wi-Fi and Bluetooth.
DIRECT COMMUNICATION
   The hair dryer includes control circuitry capable of communicating with an external device by direct communication, such as a USB port, flash memory card slot or storage card.
PROGRAMMABLE
   The hair dryer includes control circuitry that is programmable and may be configured to control the hair dryer.
HAIR DRYER MODES
   The hair dryer includes programmable modes and modulation techniques that can be updated or changed through communication with external devices.
AUTOMATIC REGISTRATION
   When the hair dryer is initially activated it automatically connects to an external device, such as a computer or the internet, and automatically registers the hair dryer for the user with the seller or manufacturer.
HAIR DRYER MODES
   The hair dryer includes programmable modes and modulation techniques that can be updated or changed through communication with external devices.
AIM SENSOR
   the hair dryer includes a sensor coupled to the control circuitry that can determine when the hair dryer is pointed at the hair.
      When the hair dryer is pointed at the hair, the sensor communicates this orientation to the control circuitry and the heating elements would be able to turn on and provide heat for drying the hair.
      When the hair dryer is not pointed at the hair, the sensor communicates this orientation to the control circuitry and the heating elements are turned off.
SENSORS
   the hair dryer includes a variety of sensors coupled to the control circuitry that are capable of detecting various properties during hair drying.
      a thermometer configured measure the remote temperature of the hair and communicate the temperature to the control circuitry.
      a distance sensor configured to measure the distance the dryer is being held from the user's head.
      an inertial sensor configured to measure the hair dryer's orientation and motion in space.
      a camera coupled with computer vision technologies such as facial and/or hair recognition to determine a user's hair type and style.
      diagnostic mechanisms configured to insure proper operation.
      a force sensor within the hair dryer configured to determine how the user is holding the handle and provide feedback by comparing values to professional stylists' data.
      an EMF sensor configured to determine the presence of magnetic fields emitted from the hair dryer to protect the user from damaged cells.
      a vibration sensor could be used to determine shock if the hair dryer unit has been dropped or damaged.
      a light sensor configured to determine how effective a camera sensor will be in analyzing the hair wetness.
PROFILE
   information from the hair dryer is used to build a profile of the user's hair.
   the profile information from the hair dryer may be used to customize the performance on other enhanced or smart devices.
   the profile information may be stored on the consumer's smartphone or tablet or backed up in the cloud.
   the sensors located on the hair dryer may be used to provide information to build the user hair profile.
      infrared thermometer is used to detect the remote temperature on the surface of the hair.
      thermometer on the hair dryer is used to detect temperature of air exiting the dryer.
      ultrasonic sensor/time-of-flight light sensor are used to detect distance from tip of dryer to the hair.
      Inertial sensors are used to detect how quickly the dryer is being moved in space.
FEEDBACK MECHANISM
   The feedback mechanism is configured to communicate hair dryer information with the user in real-time.
STERILIZER
   the hair dryer includes ultraviolet light source inside of the hair dryer configured to sterilize the inside of the hair dryer and/or sterilize the air flowing through the hair dryer

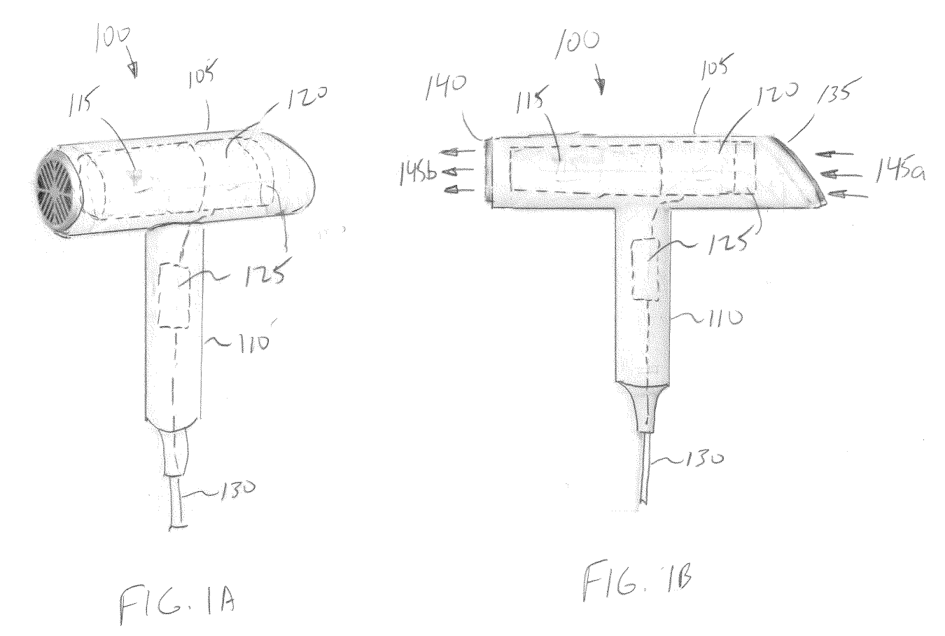

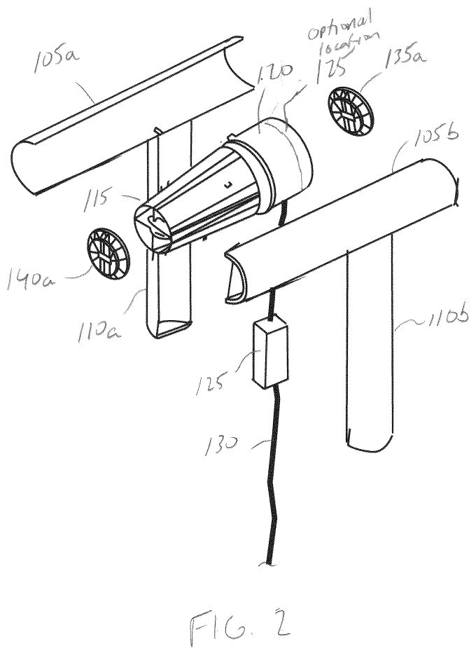

FIGS. 1A and 1B are perspective and side views showing one embodiment of a hair dryer 100 having a case 105, a handle 110, a heating element system 115, a fan 120 positioned proximate the heating element 115, electronics or control circuitry 125 and power cord 130 to power the components. The electronics or control circuitry 125 may be located in the handle 110, or located in the case, or be incorporated into the fan 120 (smart fan).

The case 105 includes air flow channel with an air inlet 135 and air outlet 140. In the embodiment shown, the fan 120 draws in air 145a through the inlet 135, the air is blown over/through the heating element 115 to heat, and the heated air 145b exits through the outlet 140.

FIG. 2 is an exploded view of FIG. 1A showing the components of the hair dryer 100 including the heating element 115, fan assembly 120, control circuitry 125 and a power cord 130. The case 105 and handle 110 may be made in multiple pieces, such as case 105a, 105b and handle 110a, 110b. The inlet 135 may include a screen 135a and the outlet may include a screen or diffuser 140a.

### Heating Element

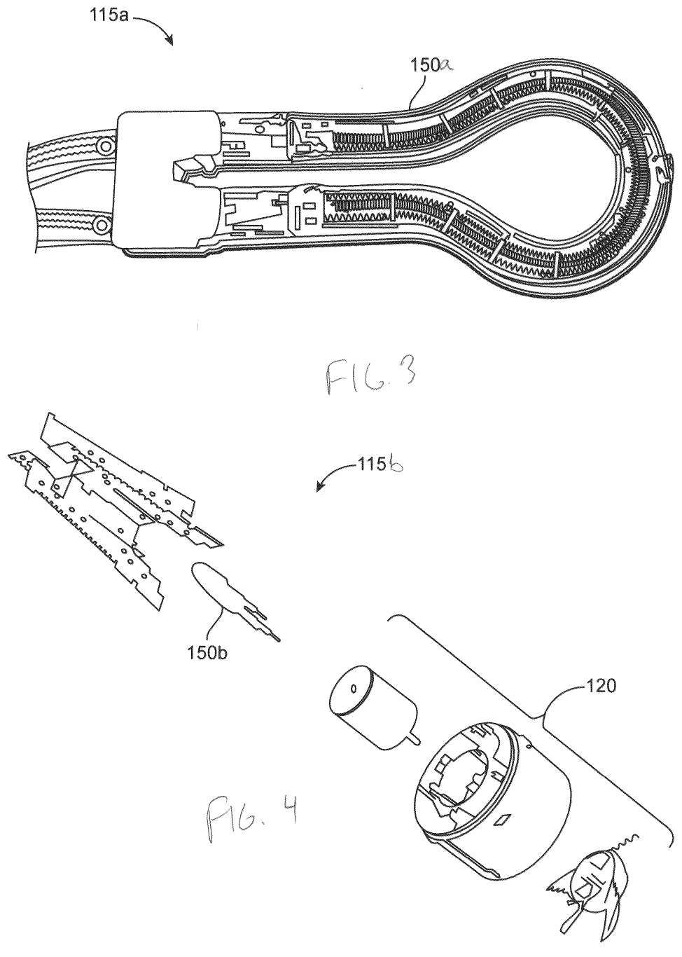

FIG. 3 shows one embodiment of a heating element system 115a that includes an infrared bulb 150a that has properties that are applicable for use in a hair dryer. For example, typical infrared bulbs have a rated life of at least 5,000 hours. Assuming each hair drying session lasts 15 minutes, this covers 20,000 hair drying sessions. Since the unit is a light bulb, techniques for focusing and controlling lighting components can be used to control the heat output of the device, such as reflective coatings on the bulb that can direct the heat out the end of the unit, providing a finer grain of control than traditional nichrome heating elements. The use of an infrared heating bulb provides a more effective transfer of heat from the hair dryer to the hair than the nichrome wire element since it is able to heat the hair without warming the air in between.

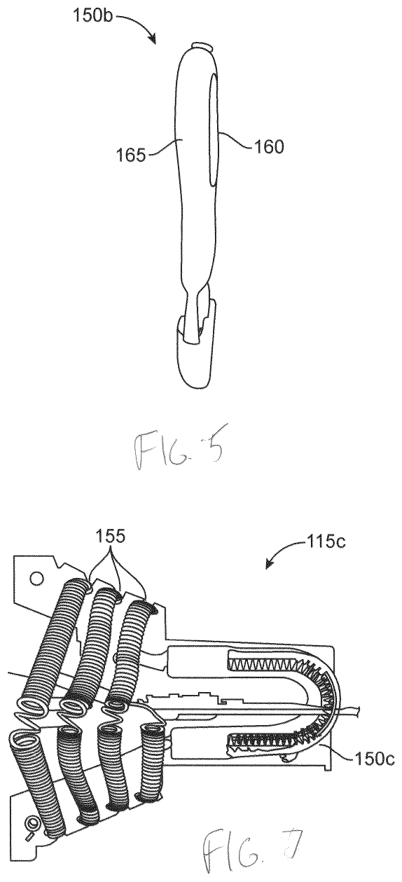

FIG. 4 shows an exploded view of another embodiment of a heating element system 115b that includes another type of infrared bulb 150b and fan 120 designed to operate in a hair dryer. To prevent heat from radiating in undesirable directions, the infrared bulb can be made into directional bulb by painting the bulb 160 with a coating 165, such as a gold coating, shown in FIG. 5. This technique can be leveraged in a hair dryer design to reduce waste heat that warms the casing of the dryer.

However, one of the downsides of an infrared bulb has a fair amount of inertia so that it takes a longer time to reach its peak temperature when compared to the resistive wire element. Some infrared bulbs take up to 20 seconds to heat up to its peak temperature

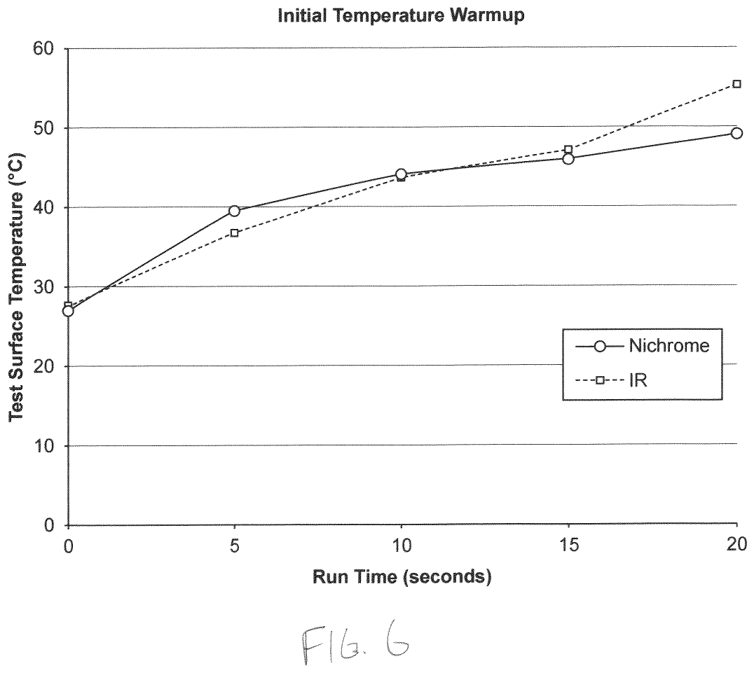

FIG. 6 shows the initial temperature warmup ramp for two heat sources: 1) resistive wire component (Nichrome); 2) infrared bulb. In some embodiments, the infrared bulb is bulkier than resistive wire and may restrict airflow through the outlet. As a result, a hybrid design that uses both heat sources may be desirable.

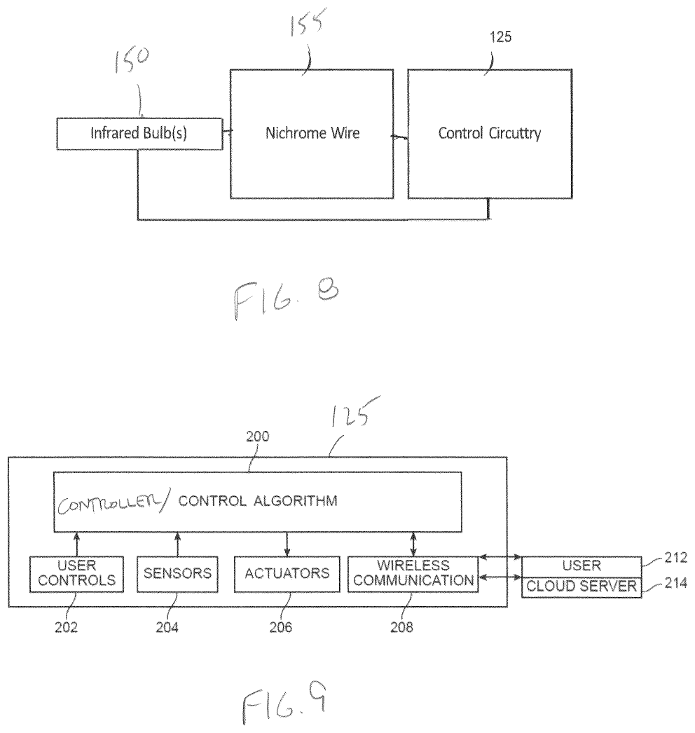

FIG. 7 shows one embodiment of hybrid heating element system 115c that combines an infrared bulb 150c with a resistive wire component 155 to provide steady state heat when the blow dryer is turned on. This is accomplished by powering the resistive wire component 155 to provide immediate heat to the blow dryer while the infrared bulb 150 warms up. Once warmed, the infrared bulb 150 then provides the heat and the resistive wire component 155 may be then reduced or turned off. Alternatively, a mix of resistive wire heating element and infrared heating (e.g., quartz tungsten) can be used in tandem simultaneously.

FIG. 8 shows a schematic of a hybrid heating element system 115 coupled to the electronics or control circuitry 125. In the embodiment shown, the heating element 115 combines an infrared bulb 150 with a resistive wire component 155 to provide steady state heat when the hair dryer is turned on. In one embodiment, the heating element 115 consists of 2×200W infrared bulbs 150, 1×200W nichrome wire component 155, and control circuitry 125. In tests, a hair dryer powered by this heating element was able to heat a room-temperature surface (73.4° F.) to an average temperature of 112.4° F. from 6 inches away.

In some embodiments, the electronics or control circuitry 125 provides power delivery to the resistive wire component 155 for immediate heat from the hair dryer while the infrared bulb 150 warms up. Once warmed, the infrared bulb 150 then provides the heat and the resistive wire component 155 may be reduced or turned off. Alternatively, a mix of resistive wire heating element and infrared (e.g., quartz tungsten) can be used in tandem simultaneously.

### Heating Element Modes

In some embodiments, the hair dryer includes programmable modes and modulation techniques capable of altering the behavior of the infrared bulbs 150 and/or nichrome wire components 155 or use modulation techniques to control the output of the infrared bulbs 150 and/or nichrome wire components 155. The modes can be stored in the control circuitry 125 or stored on one or more external devices. The modes in the control circuitry 125 can also be updated or changed through wireless or wired communication with one or more external devices.

Various modulation technique may be used for the infrared bulbs 150. including:
reducing the power a constant amount, for example 80% power to the infrared bulb;
reducing the power at various times multiple amounts for the infrared bulb, such as 100% power for a first time period, 80% power for a second time period, then 40% for a third timer period;
pulsing the power to the infrared bulb

Various modulation technique may be used for the nichrome wire components 155, including:
reducing the power a constant amount;
reducing the power at various times, such as 100% power for first time period, 80% power for a second time period, the 40% power to the end;
pulsing the power at various time intervals, where the nichrome wire component is at 100%, then to 70% and then 100%, repeating.

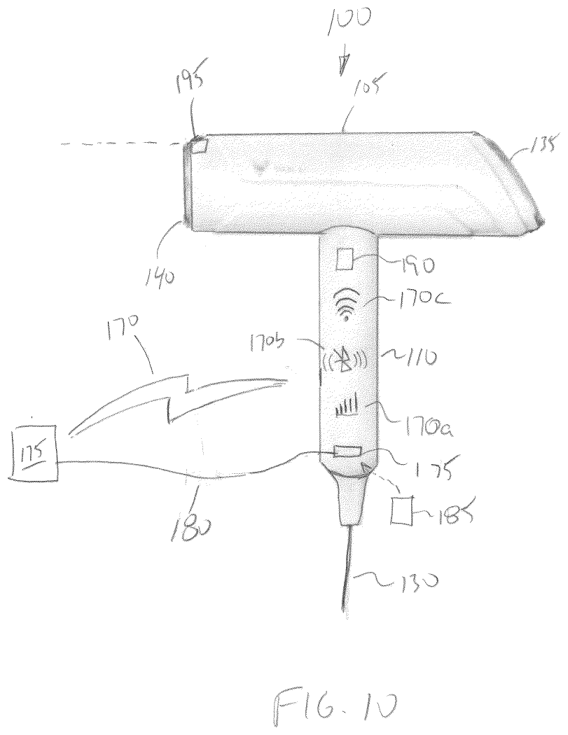

FIG. 9 is a block diagram overview showing one embodiment of functionality components of the control circuitry 125 of the hair dryer 100. The control circuitry 125 may include a controller or control algorithm 200 coupled to multiple components that manage the key features of the device that control to output of the hair dryer. The controller 200 manages heat and airflow in response to user controls or inputs 202. The controller 200 responds to data gathered by sensor readings using one or more sensors 204. These collected sensor readings 204 are used for analysis and user feedback/education based on the specific user profile type, communicating with system actuators 206. Wireless communication 208 is configured to send and receive data to an external device 214 over a wireless network connection. The data may include data gathered from the sensors, profile information from data gathered from local user equipment, updates for the software and firmware of the device. The data may also include specific user information 212.

FIG. 10 shows various smart features of the hair dryer 100.

### Wireless Communication

In some embodiments, the hair dryer is capable of wireless communication 170 with external devices 175, such as a smartphone, computer, tablet, etc. The wireless communication may use one or more wireless types, such as cellular 170a, Wi-Fi 170b and Bluetooth 170c. In one embodiment, when the hair dryer first boots up, it could boot into soft access point (soft AP) mode. The hair dryer would then show up as a Wi-Fi hotspot, and the user could connect to it via the external device. Once the hair dryer is connected to the Internet, the device can send or receive information or data with the external sources. The hair dryer may also receive updates for the software and/or firmware to add additional features or improve performance.

### Direct Communication

In some embodiments, the control circuitry 125 is capable of communicating by direct communication by inserting a data device, such as a data on a flash drive, into a port 175, such as a USB port, flash memory card slot or storage card. In some embodiments, a communication cable 185 may be plugged into the USB port 180 and directly connected to an extremal device 195, such as a computer, to send or receive information or data. In some embodiments, a USB flash device 185 may be plugged into the USB plug to communicate directly with the control circuitry to send or receive information or data with the control circuitry of the hair dryer. In some embodiments, a flash memory card or storage card 185 is inserted into the flash memory card slot or storage card slot 175 to receive information.

### Programmable

In some embodiments, the control circuitry 125 is programmable and is configured to control the hair dryer. The control circuitry 125 is configured to communicate with an external device 175, such as a computer, to receive updates for the software and/or firmware to add additional features or improve performance. In some embodiments, the control circuitry 125 is configured to send and receive the programmable information wirelessly 170 via Wi-Fi, Bluetooth or cellular connectivity or directly over a communications cable 180. In some embodiments, the control circuitry 125 receives information via a flash drive that may be plugged into the port 175 having program or updates may be plugged into the USB plug to program the hair dryer to communicate with the control circuitry of the hair dryer and to program or update the modes/algorithms in the power control circuitry In some embodiments the hair dryer may include a flash memory card slot or storage card slot that communicates with the control circuitry of the hair dryer so the programming may be delivered on a flash memory card or storage card.

In some embodiments, each component of the hybrid heating elements may be programmed.

In some embodiments, the hair dryer includes a programmable button that can be programmed to control a programmable custom setting.

In some embodiments, the hair dryer includes accelerometer technology to turn the hair dryer off automatically if there is no movement. In some embodiments, the accelerometer technology may turn the hair dryer on if it senses movement.

### Registration

In one embodiment the hair dryer may automatically be registered once the user turns hair dryer on and communicates with an external device to send the hair dryer data for registration. The communication may be done wirelessly or by direct connection. In this embodiment, when the hair dryer is initially activated it automatically connects to an external device, such as a computer or the internet, and automatically registers the hair dryer for the user with the seller or manufacturer. The registration information may include the type of hair dryer, hair dryer serial number or model number, date of purchase, location of purchase, the purchaser's information.

During this initial connection, the external device may also be configured to determine the software or programs contained in the control circuitry and provide updates or additional programs if needed.

### Identity Recognition

In some embodiments, the hair dryer includes an identity recognition device to determine if the person is an authorized user of the hair dryer. If the person is authorized, the hair dryer may be turned on and the smart modes or enhanced mode. If the person is not authorized, the hair dryer may not turn on or may turn on in a limited mode or non-smart mode. The person recognition device may be a sensor 190, such as a fingerprint sensor, or chip that communicates with the control circuitry 125. The recognition device may also be a physical interface, such as a key inserted into a key lock, a number pad to insert a code, or a card inserted into a slot.

### Sensors

In some embodiments, the invention also may contain a variety of sensors 195 coupled to the control circuitry that are capable of detecting various properties during hair drying. In some embodiments, the sensor may be a thermometer, such as a contactless infrared thermometer, configured measure the remote temperature of the hair and communicate the temperature to the control circuitry. When the ideal hair temperature has been reached, the control circuitry may use one or more techniques to adjust the heating element power output to maintain the ideal hair temperature. Such a mechanism would prevent the hair dryer from damaging the hair.

The present invention also may contain a distance sensor that measure the distance to the hair, serving as a component of the heat and airflow control algorithm that can determine how far the dryer is being held from the user's head.

The present invention also may contain an ultrasonic sensor can be used to give distance measurements several times per second. A time-of-flight infrared sensor can be used that measures the time taken for emitted light to return to the sensor, and determines the distance based on return time.

The present invention also may contain an inertial sensor may be used to measure the hair dryer's orientation and motion in space. These sensors are composed of three families: accelerometers which measure force acting on an object, gyroscopes which measure rotation around gravity, and magnetometers which measure orientation with respect to magnetic north. Many modern inertial sensors provide accelerometer, gyroscope, and magnetometer readings along x, y, and z-axes each. Such a sensor is referred to as a 9-axis sensor.

The present invention also may contain an aim sensor that is capable of determining when the hair dryer is pointed at the hair. During use the hair dryer is not aimed at the hair the entire time, only a percentage of the time. When the hair dryer is not aimed at the hairs the heating element continues to generate heat. When the hair dryer is pointed at the hair, the aim sensor allows the heating element to provide heat for drying the hair. When the hair dryer is not pointed at the hair, the sensor communicates this to the control circuitry and the heating elements are turned off. The fan may continue to run as the heating elements are turned on and off.

The hair dryer may also implement the use of a camera that uses computer vision technologies such as facial and/or hair recognition to determine a user's hair type and style. The hair dryer is also capable of communicating with a camera located on an external device to collect image frames, analyze them, and communicate profile information to the dryer (e.g., optimal heat/airflow given hair style and desired output).

Likewise, the enhanced hair dryer according to the present invention may include diagnostic mechanisms to insure proper operation. For example, microphones can be used in conjunction with analyzed waveforms from other dryer units to determine if the unit is operating normally. It could enable the product to notify the user if a component such as the fan is failing by analyzing when it doesn't sound normal.

A force sensor (or network of force sensors) could be placed in the hair dryer to determine how the user is holding the handle and provide feedback by comparing values to professional stylists' data. This information could also be fused with IMU sensor data to gauge the effect of a particular grip on the output, dry time, etc.

Electromagnetic field (EMF) sensors are useful for determining the presence of magnetic fields. Some savvy hair dryer consumers are concerned about electromagnetic field (EMF) being emitted from hair dryers since these fields can damage human cells. Onboard magnetic field sensors can provide peace of mind by ensuring the unit's generated fields are within safe limits.

A vibration sensor could be used to determine shock if the hair dryer unit has been dropped or damaged.

Light sensors can be used to determine how effective a camera sensor will be in analyzing the hair wetness. For example, a light sensor such as a phototransistor or photo resistor would be able to detect if the room is too dark for the camera to give meaningful information.

### Profile

In some embodiments, the invention may be used to define a profile for each user's hair, consisting of:
Length
Density
Coarseness
Sheen
Moisture content
Follicle thickness
Curliness
Color treatment status

This profile can be used to configure parameters for various drying and styling devices. For example, thinner hair could cause a dryer to have a lower heat output since the additional heat may not be needed to dry the hair in a reasonable amount of time. The profile could also adapt over time—by measuring how long the consumer takes to dry their hair multiple times and monitoring environmental factors such as temperature and humidity during the process, the dryer can better learn to adapt to the user's particular hair type.

The profile of the user's hair may be stored on the hair dryer, or transmitted and stored on an external device, or transmitted and stored on the internet. The profile information can be shared between various beauty products and can be used to recommend complementary products. When various devices are using the profile, they can adapt their behavior based on the information stored in the profile. For example, a consumer could purchase a hair dryer and configure it through a web site by uploading a picture of their hair and entering some additional information. Once this profile has been created, the dryer could fine-tune the heat and airflow to customize the behavior for the consumer.

In some embodiments, the same profile generated from the hair dryer may be used to customize the performance on other enhanced or smart devices. For example, if a consumer buys an enhanced flat iron, the use profile generated from the hair dryer could be used to customize the performance of the flat iron for their particular hair type. This process could be extended for other beauty products such as hot air brushes, curling irons and hot brushes.

If the profile information is stored on the consumer's smartphone or tablet or backed up in the cloud, then other devices could be customized to suit them. For example, a hotel dryer could be customized when it is in proximity of the consumer's smartphone.

### Sensors Providing Information to the Profile

Sensors located on the hair dryer may be used to provide information to build the user hair profile.
Contactless infrared thermometer—detect the remote temperature on the surface of the hair.
Contact thermometer (e.g., thermistor)—detect temperature of air exiting the dryer.
Ultrasonic sensor/time-of-flight light sensor—detect distance from tip of dryer to sensed object. Can be used to detect distance from dryer to hair.
Inertial sensors—detect how quickly the dryer is being moved in space.

In some embodiments, the proximal sensors could also be used to give a richer profile of the operating environment:
Phone's GPS—temperature/humidity/weather information.
Internet-enabled thermostat—ambient temperature and humidity of room.
Phone's camera—can be used to analyze the user's hair.

The profile can be used to configure parameters for various drying and styling devices. For example, thinner hair could cause a dryer to have a lower heat output since the additional heat may not be needed to dry the hair in a reasonable amount of time.

The profile could also adapt over time—by measuring how long the consumer takes to dry their hair multiple times and monitoring environmental factors such as temperature and humidity during the process, the dryer can better learn to adapt to the user's particular hair type.

In some embodiments, the profile information could be stored:
Locally on the device.
On a proximal smartphone, tablet, or laptop/desktop and synced via Wi-Fi/Bluetooth.
On a remote server in the cloud.

In some embodiments, the profile information can be used to:
Control the heat output of products that could damage the hair.
Fine-tune the device to perform better on the consumer's particular type of hair.
Coach the consumer by giving them feedback on their performance based on sensor measurements and comparisons to other consumers and/or professional consumers.
Recommend other products specific for the consumer's hair type (e.g., other styling devices or consumables like hairspray, heat protectant, shampoo/conditioner, color treatment, etc.).

### Feedback Mechanism

In some embodiments, the invention provides significantly richer insights into the consumer's usage habits than traditional beauty devices, additional feedback mechanisms are useful for communicating to the user in real-time. For example, if the user is holding the hair dryer too close to their hair or moving the flat iron too slowly and the hair could become damaged, it is desirable for the unit to provide feedback. The following feedback mechanisms have been contemplated:
Vibration motor—similar to a cell phone, the handle of the device could vibrate to indicate an undesirable state.
LED indicators—for units like flat irons where the consumer can often see the casing of the device, red/yellow/green status indicator LEDs can be used.
Buzzer/speaker—audible sounds/speech could be used to indicate certain conditions should change.
Proximal notifications—on the user's phone, for example.
Stored in the user's cloud profile for later coaching and feedback (similar to Fitbit but for styling).
the hair dryer includes ultraviolet light source inside of the hair dryer configured to sterilize the inside of the hair dryer and/or sterilize the air flowing through the hair dryer

### Sterilizer

In some embodiments, the hair dryer includes ultraviolet light source inside of the hair dryer configured to sterilize the inside of the hair dryer and/or sterilize the air flowing through the hair dryer. There may also be a ultraviolet light source that can sterilize a workstation.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions is possible.

1. A smart hair dryer having smart features comprising:
a hair dryer apparatus having one or more heating elements;
control circuitry coupled the hair dryer apparatus being configured to control the hair dryer apparatus and one or more heating elements; and
a communication device coupled to the control circuitry configured to communicate with one or more external devices to send and/or receive information.

2. The hair dryer of claim 1, wherein the hair dryer information received from the one or more external devices includes customized settings for an individual's personalized hair profile and the control circuitry uses the customized settings to control the hair dryer apparatus to optimize the hair drying/styling characteristics-based on the individual's personalized hair profile.

3. The hair dryer of claim 2, wherein the customized settings can be used to: control heat output of the apparatus; fine-tune the apparatus to optimize performance for the individual's hair profile; coach an individual by giving them feedback on performance and comparisons to other consumers or professional consumers; or recommend other products specific for an individual's hair profile.

4. The hair dryer of claim 1, further comprising one or more sensors coupled to the control circuitry and configured to detect and evaluate one or more hair properties during use and communicate the one or more hair properties to the one or more external devices.

5. The hair dryer of claim 4, wherein the various conditions may include:
an aim sensor configured to determine if the hair dryer apparatus is aimed at the hair;
a contactless thermometer configured measure the temperature of the hair;
a distance sensor configured to measure the distance from the hair dryer apparatus to the hair;
an inertial sensor configured to measure the hair dryer's orientation and motion in space;
a camera that uses computer vision technologies such as facial and/or hair recognition to determine a user's hair type and style;
a diagnostic mechanism to insure proper operation of the hair dryer apparatus;
an electromagnetic field (EMF) sensor configured to determine the presence of magnetic fields;
a vibration sensor configured to determine shock to the hair dryer apparatus if it has been dropped or damaged;
a feedback mechanism configured to communicate real-time usage information to the user.

6. The hair dryer of claim 1, wherein the control circuitry is programmable control circuitry, and the hair dryer information is used for programming the programmable control circuitry to optimize hair drying with the hair dryer apparatus.

7. The hair dryer of claim 1, wherein the communication device is a wireless communication device configured to provide wireless communication between the control circuitry and the one or more external devices.

8. The hair dryer of claim 1, further comprising one or more feedback mechanisms configured to communicate real-time information to the user, wherein the one or more feedback mechanisms may include:
a vibration motor configured to vibrate to indicate an undesirable state;
LED indicators of various colors to indicate a condition;
a buzzer/speaker configured to make audible sounds/speech to indicate certain conditions; or
notifications on an external device.

9. A hair dryer having smart features comprising:
a hair dryer apparatus;
one or more sensors configured to provide one or more hair properties;
programmable control circuitry coupled the one or more sensors configured to use programmable techniques based on the one or more hair properties to alter the behavior of the hair dryer apparatus; and
a communication device coupled to the control circuitry configured to send and/or receive the one or more hair properties between the programmable control circuitry and one or more external devices.

10. The hair dryer of claim 9, wherein the hair dryer information received from the one or more external devices includes customized settings for an individual's personalized hair profile and the control circuitry uses the customized settings to control the hair dryer apparatus to optimize the hair drying/styling characteristics-based on the individual's personalized hair profile.

11. The hair dryer of claim 10, wherein the customized settings can be used to: control heat output of the apparatus; fine-tune the apparatus to optimize performance for the individual's hair profile; coach an individual by giving them feedback on performance and comparisons to other consumers or professional consumers; or recommend other products specific for an individual's hair profile.

12. The hair dryer of claim 9, wherein the programmable techniques can be used to: control heat output of the hair dryer apparatus; fine-tune the hair dryer apparatus to optimize performance for the individual's hair profile; coach an individual by giving them feedback on performance and comparisons to other consumers or professional consumers; or recommend other products specific for an individual's hair profile.

13. The hair dryer of claim 9, wherein the one or more sensors is also configured to determine various conditions of the hair dryer apparatus during use, wherein the various conditions may include:
an aim sensor configured to determine if the hair dryer apparatus is aimed at the hair;
a contactless thermometer configured measure the temperature of the hair;
a distance sensor configured to measure the distance from the hair dryer apparatus to the hair;
an inertial sensor configured to measure the hair dryer's orientation and motion in space;
a camera that uses computer vision technologies such as facial and/or hair recognition to determine a user's hair type and style;
a diagnostic mechanism to insure proper operation of the hair dryer apparatus;
an electromagnetic field (EMF) sensor configured to determine the presence of magnetic fields; and
a vibration sensor configured to determine shock to the hair dryer apparatus if it has been dropped or damaged.

14. The hair dryer of claim 9, further comprising one or more feedback mechanisms configured to communicate real-time information to the user, wherein the one or more feedback mechanisms may include:
a vibration motor configured to vibrate to indicate an undesirable state;
LED indicators of various colors to indicate a condition;
a buzzer/speaker configured to make audible sounds/speech to indicate certain conditions; or
proximal notifications on an external device.

15. The hair dryer of claim 9, wherein the communication device is a wireless communication device configured to provide wireless communication between the control circuitry and the one or more external devices.

16. A hair dryer having smart features comprising:
a case having an air flow channel with an air inlet and air outlet;
one or more hearing elements positioned within the air flow channel between the air inlet and air outlet, the one or more hearing elements having two heat sources;
one or more sensors configured to provide one or more hair properties;
programmable control circuitry coupled to the one or more hearing elements and the one or more sensors, the programmable control circuitry being configured to use programmable techniques based on the one or more hair properties to alter the power of the two heat sources; and
a communication device coupled to the control circuitry configured to communicate with one or more external devices to send and/or receive information with the control circuitry.

17. The hair dryer of claim 16, wherein the one or more sensors is also configured to determine various conditions of the hair dryer apparatus during use, wherein the various conditions may include:
an aim sensor configured to determine if the hair dryer apparatus is aimed at the hair;
a contactless thermometer configured measure the temperature of the hair;
a distance sensor configured to measure the distance from the hair dryer apparatus to the hair;
an inertial sensor configured to measure the hair dryer's orientation and motion in space;
a camera that uses computer vision technologies such as facial and/or hair recognition to determine a user's hair type and style;
a diagnostic mechanism to insure proper operation of the hair dryer apparatus;
an electromagnetic field (EMF) sensor configured to determine the presence of magnetic fields; and
a vibration sensor configured to determine shock to the hair dryer apparatus if it has been dropped or damaged.

18. The hair dryer of claim 16, further comprising one or more feedback mechanisms configured to communicate real-time information to the user, wherein the one or more feedback mechanisms may include:
a vibration motor configured to vibrate to indicate an undesirable state;
LED indicators of various colors to indicate a condition;
a buzzer/speaker configured to make audible sounds/speech to indicate certain conditions; or
proximal notifications on an external device.

19. The hair dryer of claim 16, wherein the communication device is a wireless communication device configured to provide wireless communication between the control circuitry and the one or more external devices.

20. The hair dryer of claim 16, wherein the information includes hair dryer registration information that is automatically sent to register the hair dryer when the communication device initially communicates with the one or more external devices.
